(19) United States
(12) Patent Application Publication
(10) Pub. No.: US 2018/0023178 A1
(43) Pub. Date: Jan. 25, 2018

(54) PRODUCTION METHOD FOR THERMAL SPRAY PARTICLES, TURBINE MEMBER, GAS TURBINE, AND THERMAL SPRAY PARTICLES

(71) Applicant: MITSUBISHI HITACHI POWER SYSTEMS, LTD., Kanagawa (JP)

(72) Inventors: Yoshiyuki INOUE, Yokohama-shi (JP); Taiji TORIGOE, Tokyo (JP); Daisuke KUDO, Tokyo (JP); Masamitsu KUWABARA, Yokohama-shi (JP); Kei OSAWA, Yokohama-shi (JP); Yoshitaka UEMURA, Yokohama-shi (JP); Naotoshi OKAYA, Yokohama-shi (JP)

(21) Appl. No.: 15/549,819

(22) PCT Filed: Feb. 5, 2016
(86) PCT No.: PCT/JP2016/053510

§ 371 Date: Aug. 9, 2017

(30) Foreign Application Priority Data
Feb. 12, 2015 (JP) 2015-025195

(51) Int. Cl. C23C 4/12; F01D 25/00; F01D 5/28; C23C 4/10; C23C 4/18

(52) U.S. Cl. CPC C23C 4/12; C23C 4/10; C23C 4/18; F01D 5/288; F01D 25/005; F05D 2300/611

(57) ABSTRACT

The present invention provides a production method for thermal spray particles forming a ceramic layer in which vertical cracks extending in a thickness direction are dispersed in a surface direction and which includes a plurality of pores inside. The production method for thermal spray particles includes adjusting a solid content concentration of slurry (13) to 75 wt % to 85 wt %, supplying the slurry (13) to a disk-shaped atomizer (12) of a spray drying device (10), setting a protrusion speed at which the slurry (13) protrudes from the atomizer (12) to 60 m/second to 90 m/second. and performing a heat treatment on thermal spray particle bodies (22) formed by drying the slurry (13) to produce thermal spray particles composed of YbSZ in which a 50% particle diameter in a cumulative particle-size distribution is 40 μm to 100 μm.

### TECHNICAL FIELD

The present invention relates to a production method for thermal spray particles, a turbine member, a gas turbine, and thermal spray particles.

Priority is claimed on Japanese Patent Application No. 2015-025195, filed on Feb. 12, 2015, the content of which is incorporated herein by reference.

### BACKGROUND ART

In a gas turbine, a temperature of combustion gas to be used is set high in order to improve efficiency of the gas turbine. A thermal barrier coating(TBC) is applied to surfaces of turbine blade members such as blades and vanes subjected to the combustion gas having a high temperature. The thermal barrier coating is a coating of a thermal spraying material having low thermal conductivity (for example, a ceramics-based material having low thermal conductivity) applied by thermal spraying to a surface of a turbine member which is an object to be thermally sprayed. Heat-shielding properties and durability of the turbine member are improved by the thermal barrier coating.

For example, as described in PTL 1, a thermal barrier coating includes a metal bonding layer which is an undercoat layer and a ceramic layer which is a top coat layer formed on the metal bonding layer, on a surface of a heat-resistant substrate serving as a base material. The ceramic layer is formed by thermally spraying a powder mixture of ceramic powder and resin powder to the undercoat layer. The ceramic layer described in PTL 1 is so configured that vertical cracks which are cracks extending in a thickness direction and pores are dispersed in a surface direction.

### CITATION LIST

### Patent Literature

[PTL 1] Japanese Unexamined Patent Application, First Publication No. 2013-181192

### SUMMARY OF INVENTION

### Technical Problem

A dense coating having the vertical cracks described in PTL 1 is referred to as a DVC (Dense Vertically Crack) coating, Since the DVC coating is a dense structure having a vertically cracked structure, durability is improved. However, since the structure is dens in the DVC coating, porosity decreases, and heat-shielding properties are likely to decrease.

The present invention provides a production method for thermal spray particles which can form a ceramic layer having improved heat-shielding properties while securing sufficient durability, a turbine member, a gas turbine, and thermal spray particles.

### Solution to Problem

In order to achieve the above-described object, the present invention suggests the following means.

According to a first aspect of the present invention, there is provided a production method for thermal spray particles forming a ceramic layer which is formed on a heat-resistant alloy substrate used in a turbine member, the method including: adjusting a solid content concentration of slurry formed by mixing a material of the thermal spray particles, water, and a dispersant to 75 wt % to 85 wt %; supplying the slurry to a disk-shaped atomizer of a spray drying device; setting a protrusion speed at which the slurry protrudes from the atomizer to 60 m/second to 90 m/second by adjusting a rotating speed of the atomizer; and drying the slurry in the spray drying device to form thermal spray particle bodies and performing a heat treatment on the thermal spray particle bodies to produce thermal spray particles composed of YbSZ in which a 50% particle diameter in a cumulative particle-size distribution is 40 μm to 100 μm.

According to this configuration, it is possible to obtain thermal spray particles having a particle-size distribution in which the 50% particle diameter in the cumulative particle-size distribution is 40 μm to 100 μm. Accordingly, it is possible to obtain the thermal spray particles by which the ceramic layer can he formed in a state where cores of the thermal spray particles remain so as not to be melted while surfaces thereof are melted. In the ceramic layer formed by the thermal spray particles, a porous structure is formed by the remaining cores of the thermal spray particles while a dense structure is formed by the melted surfaces of the thermal spray particles. Accordingly, it is possible to obtain the ceramic layer having a porous structure including an amount of pores required for securing heat-shielding properties while having a dense structure including vertical cracks required for securing sufficient durability.

According to a second aspect of the present invention, there is provided a turbine member including a thermal barrier coating having a ceramic layer including vertical cracks and pores formed by thermal spray particles obtained by the production method for thermal spray particles.

According to a third aspect of the present invention, there is provided a gas turbine including the turbine member.

According to these configurations, it is possible to prevent the turbine member from being damaged due to exposure to a high temperature for a long period of time. Since intervals between maintenance periods can be extended, it is possible to decrease a frequency of stopping an operation of the gas turbine.

According to a fourth aspect of the present invention, there are provided thermal spray particles which form a ceramic layer formed on a heat-resistant alloy substrate used in a turbine member, wherein the thermal spray particles are composed of YbSZ in which a 50% particle diameter in a cumulative particle-size distribution is 40 μm to 100μ.

According to this configuration, it is possible to obtain the thermal spray particles by which the ceramic layer can be formed in a state where cores of the thermal spray particles remain so as not to be melted while surfaces thereof are melted. By using the thermal spray particles, it is possible to form a porous structure in the ceramic layer by the remaining cores of the thermal spray particles while forming a dense structure in the ceramic layer by the melted surfaces of the thermal spray particles. Accordingly, it is possible to obtain the ceramic layer having a porous structure including an amount of pores required for securing heat-shielding properties while having a dense structure including vertical cracks required for securing sufficient durability.

### Advantageous Effects of Invention

According to the present invention, it is possible to obtain the thermal spray particles composed of YbSZ having the particle-size distribution in which the 50% particle diameter in the cumulative particle-size distribution is 40 μm to 100 μm, and it is possible to form the ceramic layer having improved heat-shielding properties while securing sufficient durability.

### BRIEF DESCRIPTION OF DRAWINGS

FIG. 1 is a schematic configurational view of a gas turbine according to an embodiment of the present invention.

FIG. 2 is a schematic view showing an aspect in which a blade is fixed to a jig in the embodiment of the present invention.

FIG. 3 is a sectional view showing a schematic configuration of a thermal barrier coating in the embodiment of the present invention.

FIG. 4 is a view showing a flow of a production method for thermal spray particles in the embodiment of the present invention.

FIG. 5 is a schematic view showing an example of a spray drying device used in the production method for thermal spray particles.

FIG. 6 is an explanatory view of an atomizer included in the spray drying device.

FIG. 6(a) shows a plane of the atomizer.

FIG. 6(b) shows a side surface of the atomizer.

### DESCRIPTION OF EMBODIMENTS

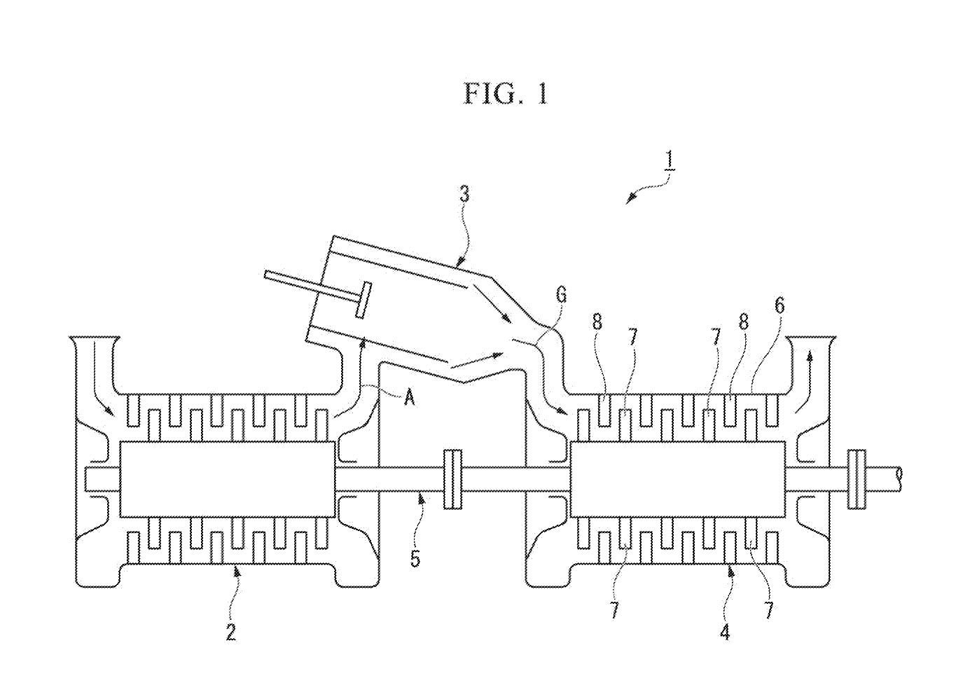

Hereinafter, an embodiment of the present invention will be described with reference to FIGS. 1 to 6.

As shown in FIG. 1, a gas turbine 1 of this embodiment includes a compressor 2, a combustor 3, a turbine body 4, and a rotor 5.

The compressor 2 takes in a large amount of air and compresses the air.

The combustor 3 mixes compressed air A compressed by the compressor 2 with a fuel and combusts the mixture.

The turbine body 4 converts thermal energy of a combustion gas introduced from the combustor 3 into rotation energy. In the turbine body 4, the thermal energy of the combustion gas G is converted into mechanical rotation energy by blowing the combustion gas G to blades (turbine members) 7 provided in the rotor 5, and power is generated. In the turbine body 4, other than the plurality of blades 7 provided on the rotor 5 side, a plurality of vanes (turbine members) 8 are provided on a casing 6 of the turbine body 4. In the turbine body 4, the blades 7 and the vanes 8 are alternately arranged in an axial direction of the rotor 5.

The rotor 5 transmits a portion of rotating power of the turbine body 4 to the compressor 2 so as to rotate the compressor 2.

Hereinafter, in this embodiment, the blade 7 of the turbine body 4 will be described as an example of the turbine member of the present invention.

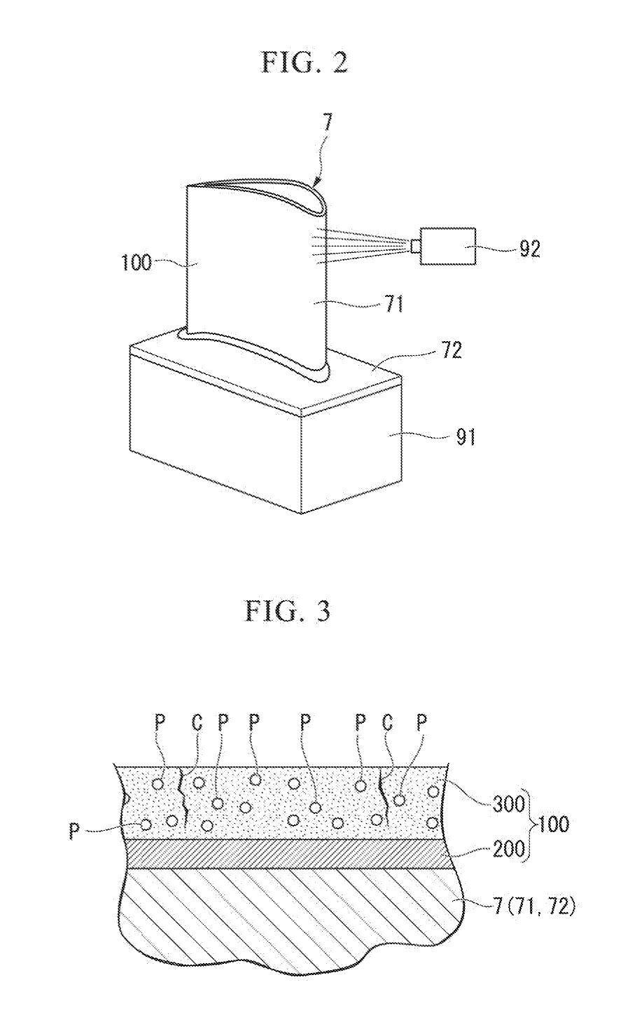

As shown in FIG. 2, for example, the blade 7 is a heat-resistant alloy substrate which is formed by a known heat-resistant alloy such as a Ni-based alloy. The blade 7 of the present embodiment includes a blade body portion 71, a platform portion 72, and a blade root portion (not shown). The blade body portion 71 is disposed in a combustion gas flow passage through which the high-temperature combustion gas G inside the easing 6 of the gas turbine flows. The platform portion 72 is provided on a base end portion of the blade body portion 71 and has a surface which intersects a direction in which the blade body portion 71 extends. The blade root portion protrudes from the platform portion 72 toward a side opposite to the blade body portion 71.

As shown in FIG. 3, a thermal barrier coating 100 is formed to cover the surface of the blade 7 which is the heat-resistant alloy substrate. In the surface of the blade 7, the thermal barrier coating 100 is formed on each of the surface of the blade body portion 71 and the surface of the platform portion 72 on a side connected to the blade body portion 71. The thermal barrier coating 100 of the present embodiment includes a metal bonding layer 200 which is laminated on the surface of the blade 7 and a ceramic layer 300 which is laminated on the surface of the metal bonding layer 200.

The metal bonding layer 200 prevents the ceramic layer 300 from being peeled, and is formed as a bonding coat layer having excellent corrosion resistance and oxidation resistance. For example, the metal bonding layer 200 is formed by thermally spraying metal thermal spray powder of an MCrAlY alloy which is thermal spray particles on the surface of the blade 7. Here, “M” of the MCrAlY alloy composing the metal bonding layer 200 indicates a metal element, and for example, indicates a single metal element such as NiCo, Ni, or Co, or a combination of two or more of then The metal bonding layer 200 of the present embodiment is integrally laminated to cover each of the surface of the blade body portion 71 and the surface of the platform portion 72 on the side connected to the blade body portion 71, The metal bonding layer 200 of the present embodiment is formed to have a film thickness of approximately 0.05 mm to 0.2 mm.

The ceramic layer 300 is a top coat layer which is formed by thermally spraying the thermal spray particles toward the surface, of the blade 7 on which the metal bonding layer 200 is formed. The ceramic layer 300 is a dense DVC (Dense Vertically Crack) coating in which vertical cracks C extending in a thickness direction of the ceramic layer 300 are dispersed in a surface direction in which a surface spreads, and a plurality of pores P are included inside the ceramic layer 300. In the ceramic layer 300 of the present embodiment, the vertical cracks C are dispersed such that the vertical cracks C per 1 mm are distributed at a pitch of 1 cracks/mm to 2 cracks/mm. The ceramic layer 300 is formed such that the porosity is within a range of 9% to 10%. The ceramic layer 300 is formed to have a film thickness of approximately 0.2 mm to 1 mm.

The porosity in the present embodiment is not an occupancy ratio of only the pores P per unit volume, and the porosity is an occupancy ratio of the vertical cracks C and the pores P combined. Accordingly, if the range of 9% to 10% of the porosity of the above-described ceramic layer 300 is expressed as the occupancy ratio of only the pores P per unit volume, preferably, the ceramic layer 300 of the present embodiment is formed such that the porosity of the ceramic layer 300 is within a range of 5% to 7%.

The thermal spray particles forming the ceramic layer 300 is composed of YbS (ytterbia stabilized zirconia) which is ZrO₂ partially stabilized by Yb₂O₃. The thermal spray particles of the present embodiment are YbSZ having a particle size distribution in which a 50% particle diameter in a cumulative particle-size distribution is 40 μm to 100 μm.

In the present embodiment, the cumulative particle-size distribution is a value which indicates the size of particles as powder, that is, as an aggregate. The cumulative particle-size distribution represents a plurality of measurement results by a distribution of an abundance ratio for each particle diameter. The 50% particle diameter in the cumulative particle-size distribution is also referred to as a median diameter. The 50% particle diameter in the cumulative particle-size distribution is a particle diameter at which the amount of particles having larger diameters becomes equal to the amount of particles having smaller diameters when the powder is divided into two at that particle diameter.

For example, the distribution of the abundance ratio tor each particle diameter of the thermal spray particles can be measured using a laser scattering diffraction type particle-size distribution measuring device or the like.

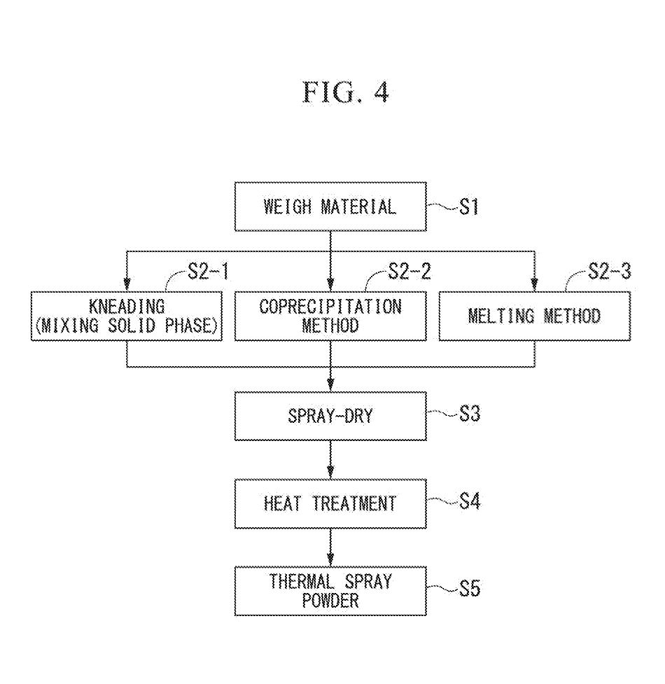

The thermal spray particles having the above-described particle-size distribution are produced by a procedure shown in FIG. 4. As shown in FIG. 4, firstly, various materials (materials of thermal spray particles) composing the thermal spray particles are weighed so as to have a target composition according to various methods at the time of preparing the slurry (Step S1). Secondly, using various materials weighed in Step S1, the slurry (mixture of powder, water, and a dispersant) is prepared by any one of kneading (solid phase mixing), a coprecipitation method, and a melting method. A solid content concentration of the slurry is adjusted to be 75 wt % to 85 wt %, and preferably, to be 78 wt % to 82 wt %. The solid content concentration is a percentage of powder in the slurry (powder, water, and dispersant) expressed by weight percentage.

The kneading is a method of charging the powder, the dispersant, pure water, and balls weighed in Step S1 to a pot (container) and kneading these for 1 hour or more by a ball mill to prepare uniform slurry (Step S2-1).

In the coprecipitation method, a neutralizing agent such as ammonia is added to a metal salt solution weighed in Step S1 to form a precipitate. In the coprecipitation method, powder is obtained by performing a heat treatment on the precipitate and thereafter, pulverizing the precipitate. Similarly to the kneading method, in the coprecipitation method, the slurry is prepared by mixing the powder with a dispersant and pure water (Step S2-2).

In the melting method, an ingot is prepared by mixing the powder weighed in Step S1, melting this mixture by arc discharge, and thereafter, cooling the mixture. In the melting method, the prepared ingot is pulverized, and similarly to the kneading method, the pulverized ingot is mixed with a dispersant and pure water to prepare the slurry (Step S2-3).

Thermal spray particle bodies are prepared by spray-dry using the slurry obtained in the above-described Steps S2-1, S2-2, and 52-3 (Step S3).

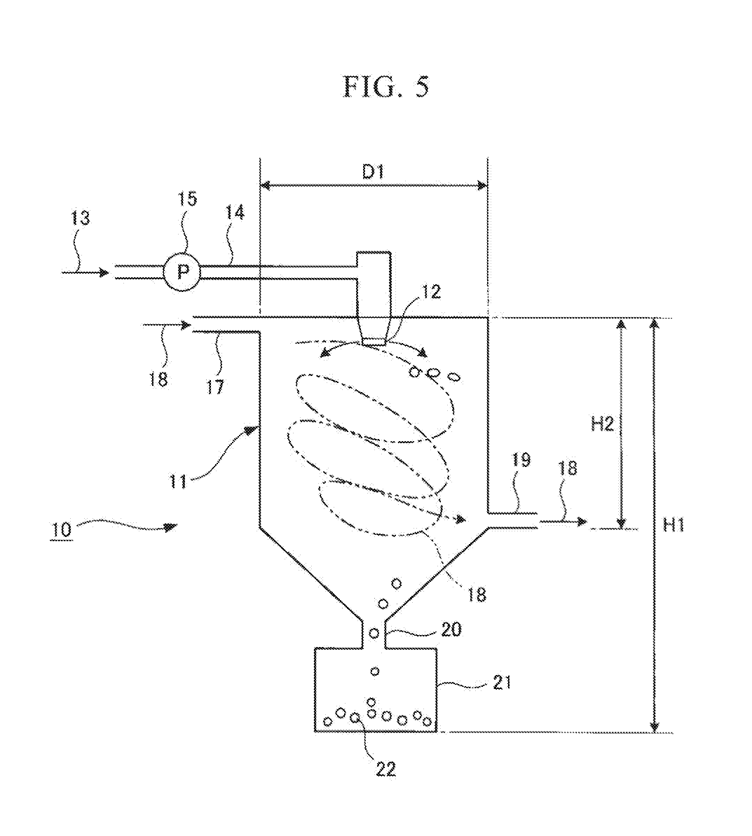

Here, a spray drying device used in the spray-dry will he described with reference to FIG. 5. As shown in FIG. 5, a spray drying device 10 includes a drying room 11, a gas supply pipe 17, a gas discharge pipe 19, and a collector 21. The gas supply pipe 17 is provided to communicate with the vicinity of a top portion in a side wall portion of the drying room 11. Accordingly, gas 18 is supplied from the outside of the system into the drying room 11. The gas discharge pipe 19 is provided to communicate with an approximately center portion of the side wall portion of the drying room 11. Accordingly, the gas 18 swirled inside the drying room 11 is discharged to the outside of the system. The collector 21 is provided to he connected to a communication pipe 20 which communicates with an approximately center portion of a bottom portion of the drying room 11. In addition, an atomizer 12 which is described in detail later is provided inside the drying room 11. A swirl flow which is swirled about the center portion of the drying room 11 is generated in the drying room 11 by the atomizer 12. Accordingly, if slurry 13 protrudes from the atomizer 12, the slurry 13 descends while swirling along with the gas 18 swirling in the drying room 11. In this process, water of the slurry 13 is dried and thermal spray particle bodies 22 are produced. Then, the thermal spray particle bodies 22 are collected in the collector 21. In the drying room 11, a diameter D1 may be 1 m or more, a height H1 from the top portion of the drying room 11 to the bottom plate portion of the collector 21 may be approximately several meters to ten and several meters, and a height H2 from the gas supply pipe 17 to the gas discharge pipe 19 may be approximately 1/1.5 to 1/4 of H1.

The atomizer 12 is provided at approximately the center portion of the top portion of the drying room 11. A slurry supply pipe 14 through which the slurry 13 prepared in the above-described steps is supplied is provided to communicate with the atomizer 12. A pump 15 which supplies the slurry is provided in the intermediate portion of the slurry supply pipe 14.

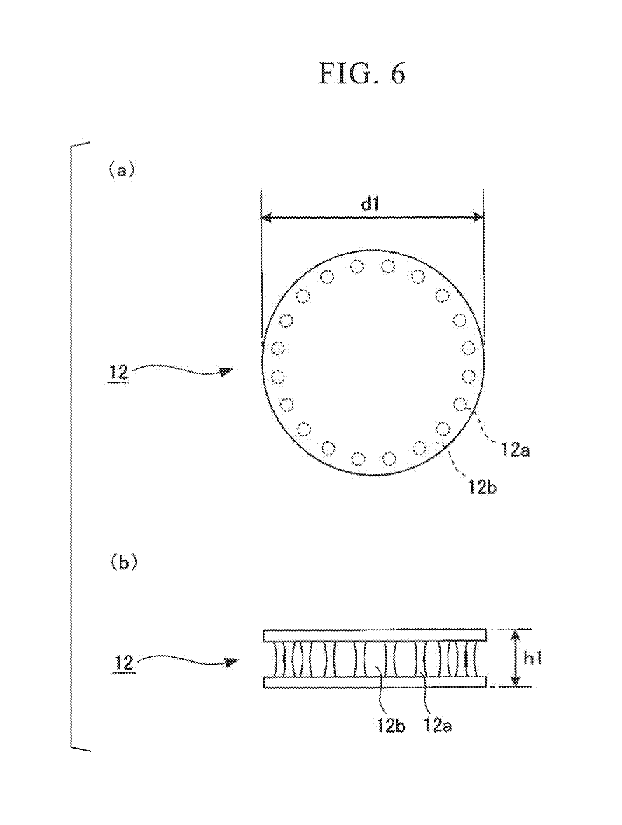

As shown in FIGS. 6(a) and 6(b), the atomizer 12 has a disk shape. In the atomizer 12, a plurality of vertical plates 12a are provided to be adjacent to each other at predetermined intervals (slits) 12b in the vicinities of the contour portions of the top plate and the bottom plate provided to face the top plate. In the atomizer 12, a diameter d1 is 50 mm to 150 mm, preferably, is 50 mm. In addition, a height h1 is 5 mm to 20 mm, preferably, is 10 mm. The slurry 13 is supplied to the inside of the atomizer 12 through a supply port (not shown). The supplied slurry 13 is discharged from the slits 12b of the rotating atomizer 12 into the drying room 11 as the thermal spray particle bodies 22.

Here, particle diameters of the thermal spray particle bodies 22 increase as a protrusion speed of the slurry 13 when the slurry 13 is discharged from the atomizer 12 decreases. Specifically, in the present embodiment, it is possible to prepare the thermal spray particle bodies 22 in which a 50% particle diameter in a cumulative particle-size distribution is approximately 100 μm by setting the protrusion speed to approximately 60 m/second. It is possible to prepare the thermal spray particle bodies 22 in which a 50% of particle diameter in a cumulative particle-size distribution is approximately 40 μm by setting the protrusion speed to approximately 90 m/second. Accordingly, by adjusting the rotating speed of the atomizer 12 of the present embodiment using a control unit (not shown), that is, by adjusting the protrusion speed of the slurry 13 from the atomizer 12 to 60 m/second to 90 m/second, the thermal spray particle bodies 22 are prepared which have a particle-size distribution in which a 50% particle diameter in a cumulative particle-size distribution is 40 μm to 100 μm. Preferably, the protrusion speed of the slurry 13 from the atomizer 12 is controlled to 70 m/second to 80 m/second.

Accordingly, the slurry 13 protrudes from the atomizer 12 and descends while swirling in the drying room 11. The thermal spray particle bodies 22 having a particle-size distribution in which a 50% particle diameter in a cumulative particle-size distribution is 40 μm to 100 μm are collected in the collector 21 through the communication pipe 20. The collected thermal spray particle bodies 22 are placed in a sheath, placed in a furnace with a thickness of the sheath adjusted to 5 cm or less, and are heat-treated at 1300° C. to 1600° C. for one to ten hours. Accordingly, solidification is performed simultaneously with sintering. Since the thermal spray particle bodies become a soft mass by the heat treatment, the mass is cracked by softly striking the thermal spray particle bodies using a pestle or the like in a mortar, and thermal spray particles are obtained. In addition, even when this work is performed, the thermal spray particles have the particle-size distribution in which the 50% particle diameter in the cumulative particle-size distribution is 40 μm to 100 μm. Accordingly, even when powder is pulverized, the particle diameter is not decreased.

Therefore, according to the production method for thermal spray particles of the present embodiment, it is possible to obtain the thermal spray particles having the particle-size distribution in which the 50% particle diameter in the cumulative particle-size distribution is approximately 40 μm to 100 μm, that is, the thermal spray particles having desired particle diameters. Accordingly, it is not necessary to perform a classification work, and it is possible to effectively obtain the thermal spray particles having desired particle diameters by the spray drying device 10. In addition, adjustment of the solid content concentration of the slurry 13 and adjustment of the rotating speed of the atomizer 12 are relatively easily performed.

Since the thermal spray particles having the particle-size distribution in which the 50% particle diameter in the cumulative particle-size distribution is 40 μm to 100 μm can he obtained, it is possible to form the ceramic layer 300 in a state where cores of the thermal spray particles re lain so as not to he melted while surfaces thereof are melted. Specifically, in the ceramic layer 300 which is formed by the thermal spray particles, a porous structure is formed by the remaining cores of the thermal spray particles while a dense structure is formed by the melted surfaces of the thermal spray particles.

Accordingly, by fanning the ceramic layer 300 using the thermal spray particles composed of YbSZ in which the 50% particle diameter in the cumulative particle-size distribution is 40 μm to 100 μm, it is possible to obtain the ceramic layer 300 having a porous structure including an amount of pores P required for securing heat-shielding properties while having a dense structure including the vertical cracks C required for securing sufficient durability. Therefore, it is possible to form the ceramic layer 300 having improved heat-shielding properties while securing, sufficient durability.

By forming the ceramic layer 300 such that the vertical cracks C are dispersed at a pitch of 1 crack/mm to 2 cracks/mm in the surface direction and the porosity is 9% to 10%, it is possible to obtain, with high accuracy, the ceramic layer 300 having improved heat-shielding properties while securing sufficient durability. Particularly, it is possible to obtain the ceramic layer 300 having higher performance by conning the ceramic layer 300 by thermal spray particles composed of YbSZ.

According to the blade 7 which is the turbine member of the above-described embodiment, it is possible to prevent the blade 7 from being damaged due to exposure to a high temperature for a long period of time. Since intervals between maintenance periods can be extended, it is possible to decrease a frequency of stopping an operation of the gas turbine 1.

Hereinbefore, the embodiment of the present invention is described in detail with reference to the drawings. However, configurations and combinations thereof in the embodiment are merely examples, and addition, omission, replacement, and other modifications of the configurations can be made within a scope which does not depart from the gist of the present invention. In addition, the present invention is not limited to the embodiment and is limited by only the claims.

In addition, the metal bonding layer 200 or the ceramic layer 300 may be formed by a method other than the present embodiment. For example, low pressure plasma spraying which is electrical thermal spraying other than atmospheric pressure plasma spraying may be used, or a flame thermal spraying method and high-speed flame thermal spraying which are gas type thermal spraying may be used. The metal bonding layer 200 or the ceramic layer 300 may be formed by a method other than the thermal spraying method and, for example, an electron beam physical vapor deposition method may be used.

In the present embodiment, the metal bonding layer 200 and the ceramic layer 300 are each formed to have the same film thickness over the entire region. However, the present invention is not limited to this and the film thickness may be appropriately set according to conditions such as an environment in which these layers are to be used.

In the present embodiment, the blade 7 is described as an example of the turbine member. The present invention is not limited to this. For example, the turbine member may be the vane 8.

### INDUSTRIAL APPLICABILITY

According to the production method for thermal spray particles, it is possible to obtain the thermal spray particles composed of YbSZ having the particle-size distribution in which the 50% particle diameter in the cumulative particle-size distribution is 40 μm to 100 μm, and it is possible to form the ceramic layer having improved heat-shielding properties while securing sufficient durability.

### REFERENCE SIGNS LIST

1: gas turbine

2: compressor

3: combustor

4: turbine body

5: rotor

A: compressed air

G: combustion gas

6: casing

7: blade

71: blade body portion

72: platform portion

8: vane

100: thermal barrier coating

200: metal bonding layer

300: ceramic layer

C: vertical crack

P: pore

10: spray drying device

11: drying room

12: atomizer

12a: vertical plate

12b: slit

13: slurry

14: slurry supply pipe

15: pump

17: gas supply pipe

18: gas

19: gas discharge pipe

20: communication pipe

21: collector

22: thermal spray particle body

1. A production method for thermal spray particles terming a ceramic layer which is formed on a heat-resistant alloy substrate used in a turbine member and includes a plurality of pores inside and in which vertical cracks extending in a thickness direction are dispersed in a surface direction,
the method comprising:
adjusting a solid content concentration of slurry formed by mixing a material of the thermal spray particles, water, and a dispersant to 75 wt % to 85 wt %;
supplying the slurry to a disk-shaped atomizer of a spray drying device;
setting a protrusion speed at which the slurry protrudes from the atomizer to 60 m/second to 90 m/second by adjusting a rotating speed of the atomizer; and
drying the slurry in the spray drying device to form thermal spray particle bodies and performing a heal treatment on the thermal spray particle bodies to produce thermal spray particles composed of YbSZ in which a 50% particle diameter in a cumulative particle-size distribution is 40 μm to 100 μm.

2. A use method for thermal spray particles forming a ceramic layer which is formed on a heat-resistant alloy substrate used in a turbine member and includes a plurality of pores inside and in which vertical cracks extending in a thickness direction are dispersed in a surface direction,
wherein the ceramic layer is thrilled by thermally spraying thermal spray particles composed of YbSZ in which a 50% particle diameter in a cumulative particle-size distribution is 40 μm to 100 μm.
